(19) United States
(12) Patent Application Publication
(10) Pub. No.: US 2006/0143339 A1
(43) Pub. Date: Jun. 29, 2006

(54) Hybrid portable communication device

(76) Inventors: Ching Yu Chang, Yi Lan Xian (TW); Kuo Ching Chiang, Taoyuan Hsien (TW); Chi Wen Liu, Hsin Chu City (TW)

Correspondence Address: THE MAXHAM FIRM, 750 "B" STREET, SUITE 3100, SAN DIEGO, CA, 92101, US

(21) Appl. No.: 11/021,270

(22) Filed: Dec. 23, 2004

(51) Int. Cl. G06F 13/38

(52) U.S. Cl. 710/62

(57) ABSTRACT

The portable device comprises a processing unit embedded in the portable device and a RF module coupled to the processing unit for wireless communication. A display and an input unit are coupled to the processing unit. A non-volatile memory is coupled to the processing unit to store data; and a computer data exchanging interface is provided. The device further comprises a computer data exchanging interface releasing unit connected to the computer data exchanging interface to release the computer data exchanging interface from the housing of the portable communication device.

### FIELD OF THE INVENTION

The present invention relates generally to a portable terminal and more particularly to a multi-function portable terminal or device.

### BACKGROUND OF THE INVENTION

Cellular communications systems typically include multiple base stations for communicating with mobile stations in various geographical transmission areas. Each base station provides an interface between the mobile station and a telecommunications network. Mobile telephone systems are in use or being developed in which the geographic coverage area of the system is divided into smaller separate cells, it communicates with the network via a fixed station located in the cell. Mobile telephones belonging to the system are free to travel from one cell to another. When a subscriber within the same system or within an external system wishes to call a mobile subscriber within this system, the network must have information on the actual location of the mobile telephone. The cellular manufactures have to release new models with different appearances, function and styles more frequently so as to attract the attention of the buyer and occupy a favorable marketing share.

### SUMMARY OF THE INVENTION

The object of the present invention is to provide a multi-function portable communication device.

The portable device comprises a processing unit embedded in the portable device and a transmission module coupled to the processing unit for wireless communication. A display and an input unit are coupled to the processing unit. A non-volatile memory is coupled to the processing unit to store data; and a USB interface is coupled to the processing unit, whereby the USB may couple to a device through the USB interface such that the portable device functions as flash drive and cellular. The device further comprises a USB interface releasing unit connected to the USB interface to release the USB interface from the housing of the portable communication device. A memory capacity detecting module is coupled to the processing unit to detect the capacity of the non-volatile memory, followed by displaying on the display. A pointer assembly is coupled to the processing unit. The pointer includes a trackball or a joy stick.

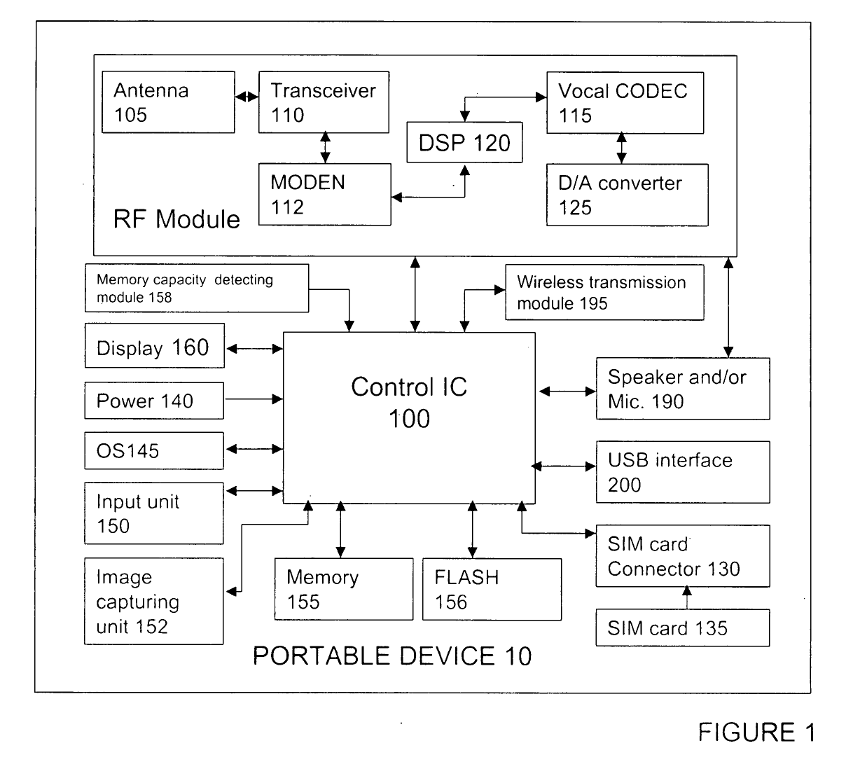

FIG. 1 shows a diagram of a portable terminal according to the present invention.

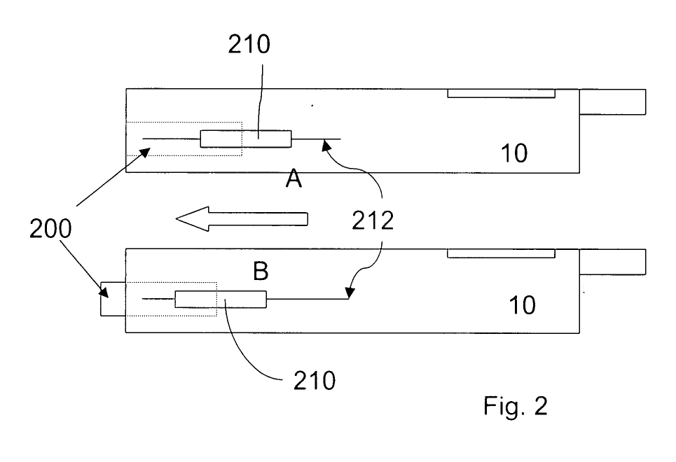

FIG. 2 shows a diagram of a interface releasing unit according to the present invention.

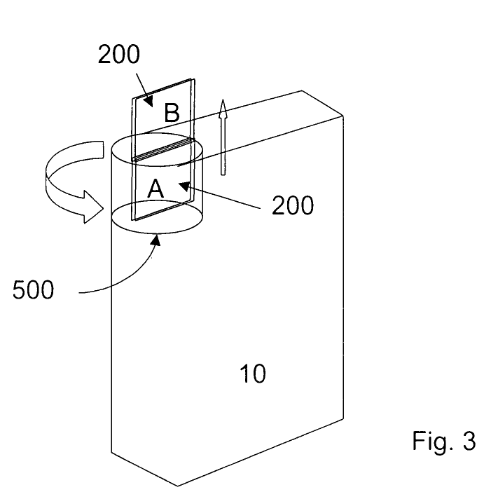

FIG. 3 shows a diagram of a interface releasing unit according to the present invention.

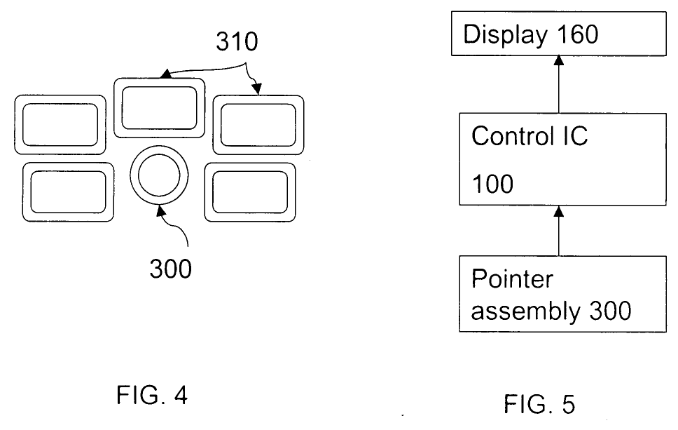

FIGS. 4 and 5 show a diagram of a pointer assembly according to the present invention.

### DETAILED DESCRIPTION

The present invention relates to a Hybrid Portable Communication Device (HPC) with multi-function. The portable device according to the present invention includes but not limited to cellular, PDA (personal digital assistant), smart phone and the equivalent thereof.

FIG. 1 shows a block diagram of a hybrid portable communication device with SIM card connector 130 to carry the SIM card 135, it is well know in the art, the SIM card is not necessary for some other type of cellular such as PHS system. The diagram is used for illustrating and not used for limiting the scope of the present invention. The portable terminal or device 10 includes a RF module. As know in the art, the RF signal transmission module includes antenna 105. This antenna 105 is connected to a transceiver 110, which is used to receive and transmit signal. AS know, the RF module further includes MODEN 112, CODEC 115, DSP 120 and A/D converter as well. Due to the RF module is not the feature of the present invention, therefore, the detailed description is omitted. The present invention includes a central control IC 100, an input unit 150, a build-in display 160, OS 145, power 140 and memory 155 including a ROM program memory, a RAM memory. All of the components are coupled to the Control IC 100. Nonvolatile FLASH memory 156 is coupled to the control IC 100. The RF module may perform the function of signal transmitting and receiving, frequency synthesizing, base-band processing and digital signal processing. The SIM card hardware interface is used for receiving a SIM card. Finally, the signal is send to the final actuators, i.e. a loudspeaker and a microphone 190.

The present invention includes one or more following module that is not disclosed by the current cellular terminal. It should be noted that the additional module can be implanted along or combination depending on the necessary. A data exchange interface 200 is provided and coupled to the control IC 100. The data exchange interface 200 is capable of coupling to the I/O port of a computer system, directly or indirectly. The data exchange interface 200 provides the interface for exchanging the information between the portable device and the computer system. At current, the conventional cell-phone is incapable communicated with the computer system by its built-in unit. The data exchange interface 200 is preferred a USB (universal serial bus) interface or Fire Wire interface or the IEEE 1394. The USB or the Fire Wire 200 is provided and coupled to the control IC 100. Through the USB interface or the Fire Wire 200, the user may transmit the data such as E-mail, MP3 file, image file (taken by the image capturing unit 152) or downloaded data to the computer. Alternatively, the portable device 10 may update information such as OS, program or the like from the computer system. At present, the user can not send the digital picture to the computer directly by the conventional cell-phone device.

Moreover, the element constructed by the USB 200, the flash memory 156 and control IC 100 functions as a flash drive. Therefore, the present invention integrated the cell phone and the flash drive. The present Hybrid Portable Communication Device (HPC) is provided with a plug-in type interface for connecting to the USB (Universal Series Bus) port or the Fire Wire port of the personal computer. A control IC is coupled to the USB or the Fire Wire interface 200. The USB interface is capable of dealing with the USB protocol. The flash memory 156 operates the mode under instruction or command. The operation mode includes read mode, write mode, erase mode, and programming mode. A USB interface 200 is in connection with the controller 100 at one end, thereby creating an electrical connection. A part of the USB or the Fire Wire interface 200 maybe extended outside the housing of the flash drive-like cellular. The inner end of the interface 200 fastened into the inside of the housing. The aforementioned USB interface 200 could be A-type USB interface with a flat and wide shape, or B-type USB interface with a rectangular shape or a Mini-type USB interface with a flat and narrow shape. The definition of USB type may refer to US Patent Application No. 20040038592, entitled “USB flash drive”. The flash memory could be replaced by other NVM (non-volatile memory) such as NROM (nitride-ROM), SONOS or MRAM, FRAM. The present HPC may function as memory drive. The memory drive refers to a commercial memory device with USB interface such as flash drive.

The flash memory 156 can be coupled to the USB or the Fire Wire ports of personal computer, digital camera, etc. by means of the Fire Wire or USB interface 200 which is commercially available products. For the digital camera user, the capacity of the camera's memory card is small. The user has to change the memory card, frequently. One aspect of the present invention is that the digital camera or digital video camera may couple to the flash drive like cellular or called HPC, thereby transferring the data or the image file to the flash memory 156 of the portable device through the USB interface 200. Further, the present invention also includes a wireless transmission unit for short distance transmission between the cellular and a computer.

Another aspect of the present invention is that a Fire Wire or USB interface releasing unit 210 is provided to release the Fire Wire or the USB interface 200 from the housing of the portable device 10. Please turning to FIG. 2, the USB interface 200 extends from the hosing of the device 10 by pushing or pressing the USB interface releasing unit 210. In one example, the releasing unit 210 is movable from position A to B along a slot 212, indicated by an arrow in the illustration. Alternatively, the interface 200 may be extending by tuning or rotating a holder 500 of the interface. The mechanism is similar to the lip stick holder, as shown in FIG. 3. The interface 200 is held within the holder 500, it is indicates by interface A. After the holder 500 is rotated, the interface 200 is extended out of the holder 500 and is indicated by interface B. Alternatively, the interface 200 may be capped by a cap or ejecting from the housing by an ejecting means.

A further aspect of the present invention includes a memory capacity detecting module 158 coupled to the control IC 100 to detect the capacity of the flash, followed by displaying on the display 160.

FIG. 4 and FIG. 5 illustrate a view of a pointer assembly 30 such as joy stick apparatus or trackball in accordance with preferred embodiments of the present invention. A joy stick member or trackball 300 is mated to a shaft on a keyboard 310. The joystick member 300 may be disposed between keys and coupled to a sensor (not shown). The sensor communicates the signals indicating direction and magnitude of movement to the control IC 100, which in turn controls the movement of a graphical object such as cursor displayed on the display according to information of signals. The pointer assembly is in communication with sensor embedded between keys within a keyboard assembly. As known the pointer assembly is capable of selecting the file or data that is selected by the user. The assembly is helpful to the user to transmit the data between the HPC and PC via the USB interface. Further, the user may use the pointer assembly 30 through the interface 200 to control the object shown on the computer display during playing computer games. For instance, in digital games, the movement of the pointer assembly 300 could move a graphical object of game, such as weapon, person or controlled feature. The sensed signals method or the pointer assembly is described in U.S. Pat. Nos. 5,546,334, 6,091,404, 5,568,987. The references are incorporated for reference.

As will be understood by persons skilled in the art, the foregoing preferred embodiment of the present invention is illustrative of the present invention rather than limiting the present invention. Having described the invention in connection with a preferred embodiment, modification will now suggest itself to those skilled in the art. Thus, the invention is not to be limited to this embodiment, but rather the invention is intended to cover various modifications and similar arrangements included within the spirit and scope of the appended claims, the scope of which should be accorded the broadest interpretation so as to encompass all such modifications and similar structures. While the preferred embodiment of the invention has been illustrated and described, it will be appreciated that various changes can be made therein without departing from the spirit and scope of the invention.

What is claimed is:

1. A portable device comprising:
a processing unit embedded in the portable device;
a transmission module coupled to the processing unit for wireless communication;
a display and an input unit coupled to the processing unit;
a non-volatile memory coupled to the processing unit to store data;
a data exchanging interface coupled to said processing unit, whereby said data exchanging interface may couple to a computer system through said data exchanging interface such that the portable device functions as memory drive and cellular.

2. The portable device of claim 1, wherein said data exchanging interface includes a USB interface or Fire wire interface or IEEE 1394.

3. The portable device of claim 2, further comprising an interface releasing unit connected to the interface to release the interface from the housing of the portable communication device.

4. The portable device of claim 3, wherein said interface is released by pushing, rotating or ejecting.

5. The portable device of claim 1, further comprising a memory capacity detecting module coupled to the processing unit to detect the capacity of the non-volatile memory, followed by displaying on said display.

6. The portable device of claim 1, further comprising a pointer ssembly coupled to said processing unit.

7. The portable device of claim 6, wherein said pointer assembly includes a trackball or a joy stick.

8. A portable device comprising:
a processing unit embedded in said portable device;
a non-volatile memory coupled to said processing unit to store data;
a display coupled to said processing unit;
a USB interface coupled to said processing unit;
a memory capacity detecting module coupled to said processing unit to detect the capacity of said non-volatile memory, followed by displaying on said display.

9. The portable device of claim 8, further comprising a USB interface releasing unit connected to said USB interface to release said USB interface from the housing of said portable device.

10. The portable device of claim 9, wherein said interface is released by pushing, rotating or ejecting.

11. The portable device of claim 8, further comprising a pointer assembly coupled to said processing unit.

12. The portable device of claim 11, wherein said pointer assembly includes a trackball or joy a stick.

13. A portable device comprising:
a processing unit embedded in said portable device;
a transmission module coupled to said processing unit for wireless communication;
a display and an input unit coupled to said processing unit;
a non-volatile memory coupled to said processing unit to store data; and
a pointer assembly coupled to the processing unit to input signal indicating direction and magnitude of movement to the processing unit, which in turn controls the movement of a graphical object displayed on said display or on a computer display coupled to the portable device.

14. The portable device of claim 13, further comprising a data exchanging interface coupled to said processing unit, whereby said data exchanging interface may couple to a computer system through said data exchanging interface such that said portable device functions as memory drive and cellular.

15. The portable device of claim 14, wherein said computer data exchanging interface includes a USB interface or fire wire interface or IEEE 1394.

16. The portable device of claim 13, further comprising an interface releasing unit connected to said interface to release said interface from the housing of said portable communication device.

17. The portable device of claim 16, wherein said interface is released by pushing, rotating or ejecting.

18. The portable device of claim 13, further comprising a memory capacity detecting module coupled to said processing unit to detect the capacity of said non-volatile memory, followed by displaying on said display.

19. The portable device of claim 13, wherein said pointer assembly includes a trackball or a joy stick.
